(19) United States
(12) Patent Application Publication
(10) Pub. No.: US 2009/0086471 A1
(43) Pub. Date: Apr. 2, 2009

(54) ILLUMINATED LANDSCAPE MODULE FOR EXISTING EDGING SYSTEM

(76) Inventor: James E. Bollman, Walker, MI (US)

Correspondence Address: MCGARRY BAIR PC, 32 Market Ave. SW, SUITE 500, GRAND RAPIDS, MI, 49503, US

(21) Appl. No.: 12/328,599

(22) Filed: Dec. 4, 2008

Related U.S. Application Data
(63) Continuation-in-part of application No. 11/830,046, filed on Jul. 30, 2007, now Pat. No. 7,473,006.

(51) Int. Cl. F21S 8/00

(52) U.S. Cl. 362/152

(57) ABSTRACT

An illuminated edging module is provided for attaching a light strand (e.g. a rope light) to an existing conventional edging. The edging module includes a housing comprising an elongated connector portion adapted to removably couple the edging module to the upper portion of the existing edging and a housing upper portion containing the light strand. The housing upper portion can be translucent or transparent. The housing portion and the connector portion are integrally formed of plastic and can be co-extruded so that they are made of different materials. A translucent or transparent coupler formed as a slotted cylinder and surrounding the housing upper portion can be used to join adjacent sections of the illuminated edging module. One or more sleeves can be provided with a coloring to color the light emitted from the light strand when it is attached over the housing upper portion.

### CROSS-REFERENCE TO RELATED APPLICATION

This application is a continuation-in-part of U.S. patent application Ser. No. 11/830,046, filed Jul. 30, 2007, which is incorporated herein in its entirety.

### FIELD OF THE INVENTION

This invention relates to landscape edging products, including without limitation edging for lawns, sidewalks, trees, flower beds and the like, with lighting fixtures integrated therein.

### BACKGROUND OF THE INVENTION

Edging is used in a variety of landscaping applications, generally to separate one defined area from another (e.g. a lawn from a flower bed). A profile of a typical edging product 1 is shown in FIG. 1. The edging is generally made of plastic and has an upper hollow tube portion 2 and a flat lower portion 3. The edging is typically installed so that fins 4 anchor the lower portion 3 in the ground, with only the tube portion 2 visible above grade. Edging 1 is sold in rolls of various lengths (20 feet, 40 feet, 60 feet, etc.) and is typically installed in either a straight or curved path. Multiple sections can be joined form edging with a uniform appearance and any desired length. The edging is typically made in a dark or neutral color to visually blend with the landscape.

Flexible strands of lights (sometimes called rope lights) are used in a number of applications for decorative purposes. For example, rope lights are often used in holiday decorations and accent lighting in the home (on deck railings, kitchen cabinets, crown moldings, etc.)

It is desirable to provide edging which integrates outdoor lighting for safety, convenience and appearance. In particular, it is desirable to adapt rope lights or the equivalent for outdoor installation in landscape edging.

### SUMMARY OF THE INVENTION

The present invention provides an illuminated edging system including an edging section having an upper portion and a lower portion; the upper portion is an elongated enclosure open only at an end thereof A light strand (e.g. a rope light) is disposed inside the upper portion, with an electrical connector at an end of the light strand and disposed inside the upper portion. The lower portion is configured to be installed below grade, so that the upper portion with the light strand rests on the ground.

In an embodiment, the upper portion and the lower portion are integrally formed of plastic, and the upper portion is translucent or transparent. The upper portion and lower portion can be formed by a co-extrusion process, so that the upper portion is translucent or transparent and the lower portion is not translucent or transparent.

In an embodiment, the edging system has a plurality of edging sections and a translucent coupler for joining adjacent edging sections, with the coupler disposed on the exterior of the respective upper portions of the adjacent edging sections. The coupler can be formed as a slotted cylinder surrounding the upper portion, the lower portion extending through the slot. A weather-resistant coupling of the rope light can be disposed inside the upper portion of the edging section, between the light strand and the electrical connector. The connector can also be a round solid or hollow cylinder that is frictionally fitted into the upper portion of the edging section.

According to another embodiment of the invention, one or more sleeves can be provided with a coloring to color the light emitted from the light strand when it is attached over the upper portion. The one or more sleeves can be attached to the upper portion partially or fully along the length of the upper portion. The sleeves can be used with the upper portion alone or in combination with one or more couplers.

In another embodiment, an illuminated edging module is provided for attaching a light strand to an existing conventional edging. The illuminated edging module includes a housing comprising an elongated connector portion adapted to fit to the upper portion of the existing conventional edging and a housing upper portion containing a light strand. The connector portion removably attaches to the upper portion of the existing conventional edging.

In yet another embodiment, the connector portion and the housing upper portion of the illuminated edging module are integrally formed of plastic, and the housing upper portion is translucent or transparent. The connector portion and the housing upper portion of the illuminated edging module can be formed by a co-extrusion process, so that the housing upper portion is translucent or transparent and the connector portion is not translucent. The connector portion and the housing upper portion can both be formed so as to be transparent or translucent.

In another embodiment of the invention, one or more couplers can be provided for joining adjacent edging modules. The coupler is formed as a slotted cylinder surrounding the upper portion of the housing of the edging module. The coupler is disposed on the exterior of the housing upper portions of adjacent edging modules and can be translucent or transparent. The coupler can also be disposed on the interior of the housing upper portions of adjacent edging modules.

According to another embodiment of the invention, one or more sleeves can be provided with a coloring to color the light emitted from the light strand when it is attached over the housing upper portion. The one or more sleeves can be attached to the housing upper portion partially or fully along the length of the housing upper portion. The sleeves can be used with the housing upper portion alone or in combination with one or more couplers.

The foregoing has outlined, rather broadly, the preferred features of the present invention so that those skilled in the art can better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals:

FIG. 1 is a schematic cross-sectional view of a typical edging product.

FIG. 2A is a cross-sectional view of edging with an internal light strand, in accordance with an embodiment of the invention.

FIG. 2B is a perspective view of two sections of edging with an external coupler and an internal light strand, in accordance with an embodiment of the invention.

FIG. 2C is a perspective view of two sections of edging with an external sleeve and an internal light strand, in accordance with an embodiment of the invention.

FIGS. 3A and 3B are schematic illustrations of weather resistant electrical connectors at the ends of a light strand, in accordance with an embodiment of the invention.

FIG. 3C is a perspective view of a weather-resistant electrical connection in a section of edging, in accordance with an embodiment of the invention.

FIG. 3D is a perspective view of multiple edging sections joined by external couplers, with a weather-resistant electrical and mechanical connection between two internal light strands, in accordance with an embodiment of the invention.

FIG. 4A schematically illustrates a connector for a light strand to a power cord and plug, for connecting the lighting portion of the edging to a power source.

FIG. 4B is a detail view of the power plug with a 2-5 watt fuse shown in FIG. 4A.

FIG. 5 schematically illustrates an installation of lighted edging in accordance with an embodiment of the invention.

FIG. 6 is a perspective view of an illuminated edging module for mounting to an existing conventional edging system, according to another embodiment of the invention.

FIG. 7 is a perspective view of two sections of an illuminated edging module with an external coupler and an internal light strand, in accordance with an embodiment of the invention.

FIG. 8 is a perspective view of two sections of an illuminated edging module with an external sleeve and an internal light strand, in accordance with an embodiment of the invention.

FIG. 9A is a cross-sectional view of the illuminated edging module illustrated in FIG. 6 prior to mounting to an existing conventional edging system.

FIG. 9B is a cross-sectional view of the illuminated edging module illustrated in FIG. 6 mounted to an existing conventional edging system.

FIG. 10 is a perspective view of a colored sleeve for use with the illuminated edging module illustrated in FIG. 6.

FIGS. 11A-D are top views showing exemplary additional colored sleeve for attachment to the invention of FIGS. 1-10, which, e.g., can have colors which correspond to various conventional holiday color combinations, favorite sport team color combinations, or any other color selection based on the aesthetic tastes of the user.

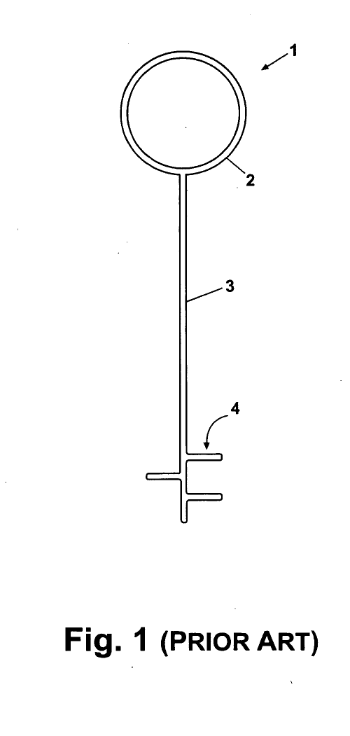

### DETAILED DESCRIPTION

It is to be understood that the invention is not limited in its application to the details of the particular arrangement shown, since the invention is capable of other embodiments. Furthermore, the terminology used herein is for the purpose of description and not of limitation.

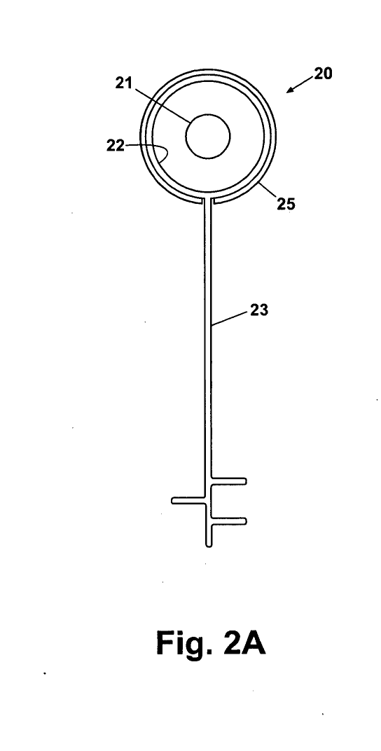

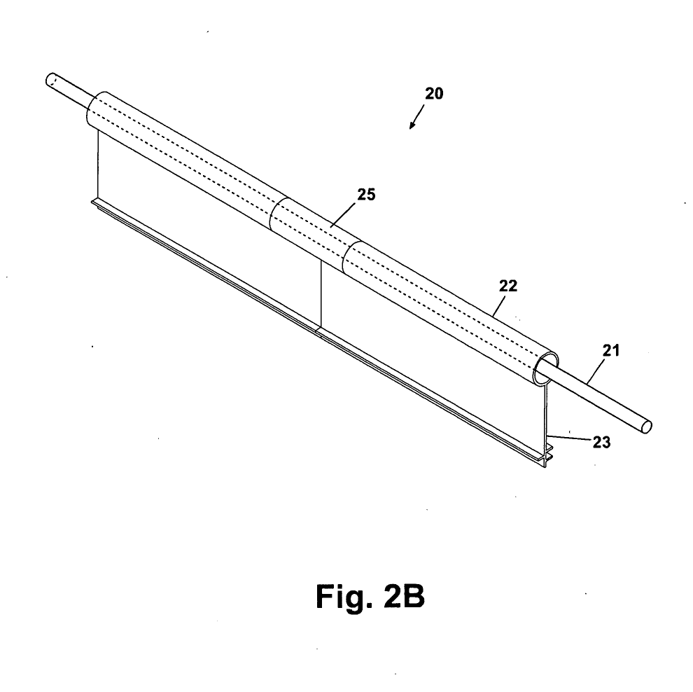

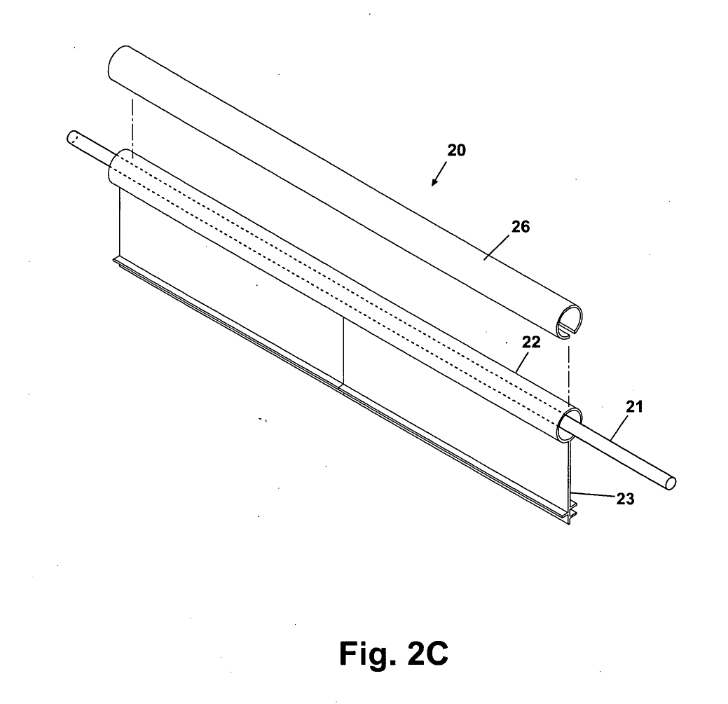

An embodiment of the invention is schematically illustrated in FIGS. 2A and 2B.

FIG. 2A is a cross-sectional view of a section of edging 20 having an upper tube portion 22 and a lower portion 23. A flexible strand 21 of lights (e.g. rope lights) is installed inside tube portion 22. As shown in FIG. 2B, the tube portion 22 is an elongated enclosure, open only at the ends thereof, and has a substantially circular cross section. The light strand 21 preferably has a circular cross-section, but can have any cross-sectional shape that fits conveniently into tube portion 22.

Sections of the edging 20 are coupled together using a coupler 25. In an embodiment, coupler 25 is an external coupler having the shape of a slotted hollow cylinder surrounding tube portion 22; the lower portion 23 extends downward through the slot. In an alternative embodiment, the coupler is an internal coupler disposed on the interior of the respective upper portions of the adjacent edging sections.

The tube portion 22 and coupler 25 are made of transparent or translucent plastic so that light from strand 21 is visible. In one embodiment, the coupler 25 covers the tube portion 22 only in the vicinity of a joint between two sections of edging, as shown in FIG. 2B.

As illustrated in FIG. 2C, the coupler 25 can also be provided in long sections to form a sleeve 26 for providing a continuous covering of the tube portion 22. The sleeve 26 can be used with one or more upper tube portions 22 without the coupler 25 or the sleeve 26 can be used in combination with one or more upper tube portions 22 connected by one or more couplers 25.

When used in combination with the coupler 25, the sleeve 26 can snap-fit over the tube portion 22 of adjacent edging sections 20 across the coupler 25. The sleeve 26 can be sized so as to fit around the tube portion 22 and the coupler 25. Additionally, the sleeve 26 can be used instead of the coupler 25 to couple adjacent edging sections 20 and provide a cover for the one or more tube portion 22. The sleeve 26 can be made of transparent or translucent plastic so that light from strand 21 is visible.

Either of the tube portion 22, the coupler 25 or the sleeve 26 can be formed without coloring, or can be colored so as to impart a color to the visible light emanating from strand 21, or from a portion of the strand. Alternatively, the lights of strand 21 can themselves be of a variety of colors. The lights can be incandescent or have light-emitting diodes (LEDs).

In one embodiment, tube portion 22 can be transparent while the sleeve 26 can be any of a variety of colors. A long, continuous sleeve 26 can be of a single color or can have more than one color disposed along its length. The colors can be randomly disposed along the length of the sleeve 26 or they can form a repeating pattern, such as red, white and blue, for example. The sleeve 26 can also be provided in shorter, colored segments that the user can attach to the illuminated edging 20 to generate a desired color pattern.

The tube portion 22 (either alone or in combination with one or both of the coupler 25 and the sleeve 26) protects the light strand 21 from weather and from physical damage (e.g. by weed trimmers, by being stepped upon, etc.). A UV inhibitor can be added to the plastic to protect the light strand 21 from the sun.

The lower portion 23 of the edging 20 can be formed in an extrusion process along with the upper portion 22, so as to have the same translucent or transparent properties as the upper portion. Alternatively, the lower portion can be formed in a co-extrusion process so that the upper and lower portions 22, 23 are made of different materials; the plastic of the lower portion 23 therefore can be opaque while the upper portion 22 is transparent or translucent. Both the upper and lower portions 22, 23 can also be made transparent or translucent.

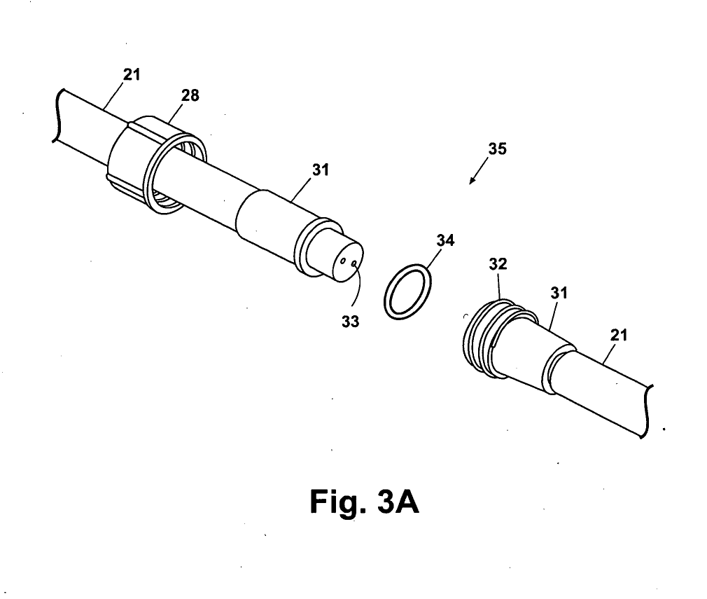

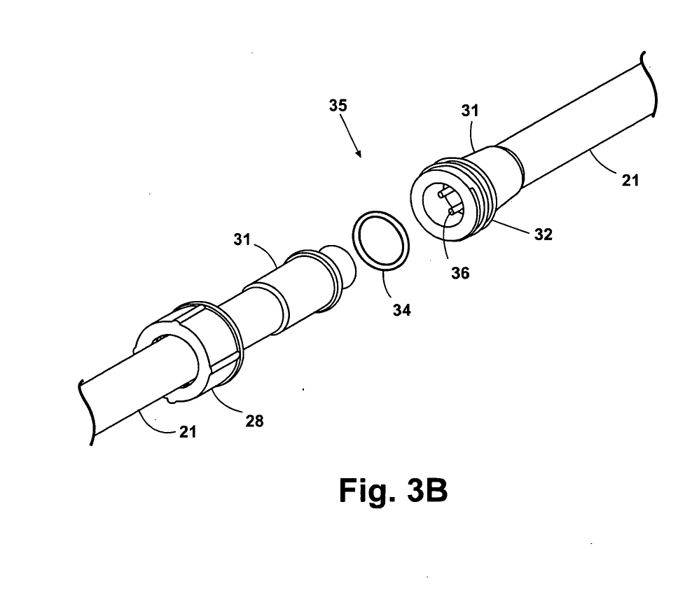

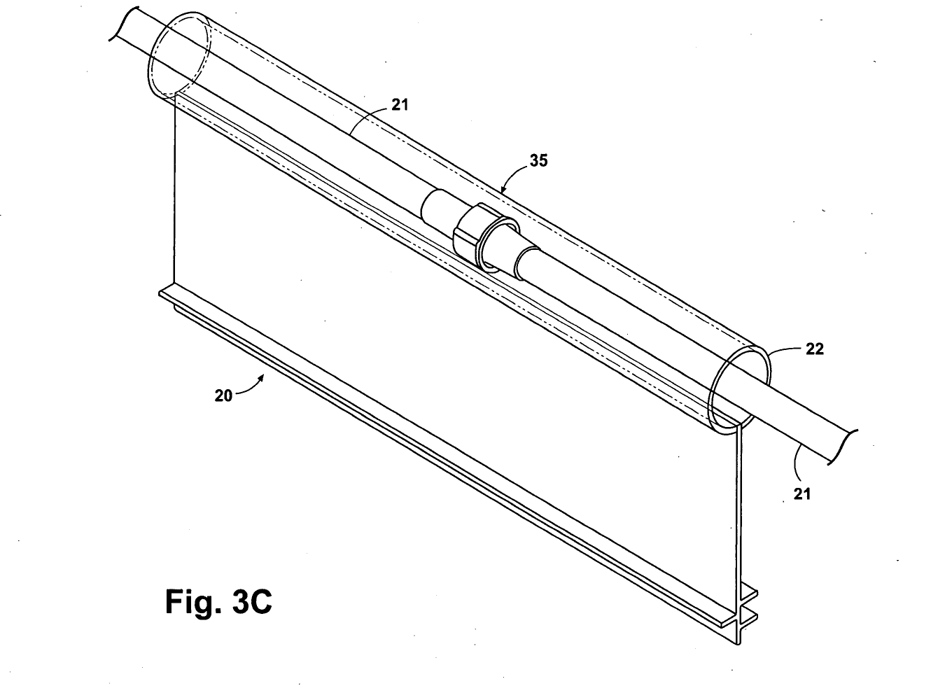

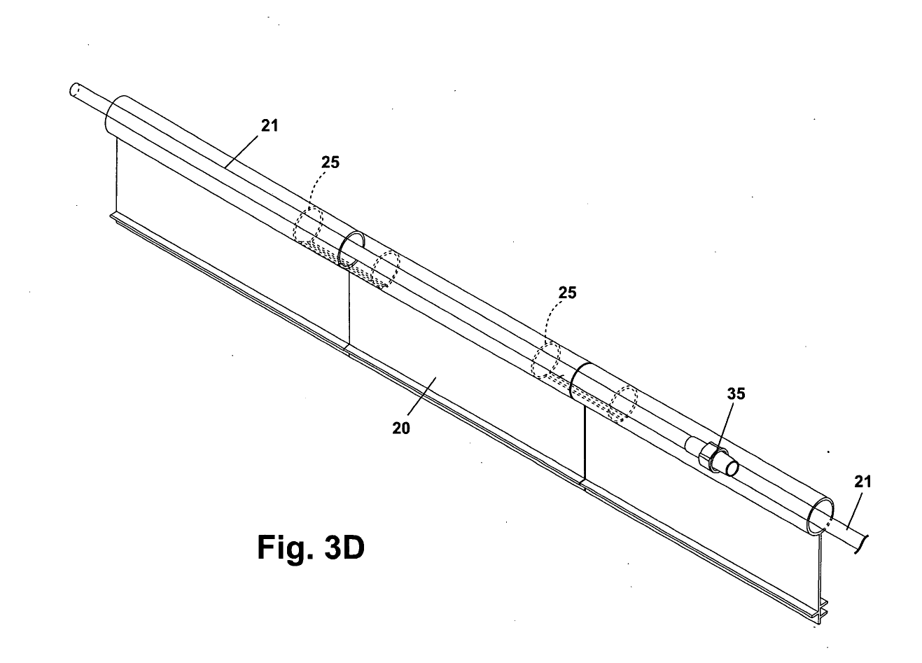

In an embodiment, a weather-resistant electrical connector is located at each end of light strand 21, to connect the lights in series. FIGS. 3A and 3B show a connection between two light strands 21, viewed from different angles. An electrical plug 36 (FIG. 3B) at the end of light strand 21 mates with a socket 33 (FIG. 3A) at the end of a neighboring light strand 21. The junction between light strands 21 is protected by a weather-resistant mechanical connector 35 having two sections 31, fastened together by a coupling nut 28 threading onto a threaded portion 32, and sealed using an O-ring 34. Although FIGS. 3A and 3B illustrate a connection for a two-wire rope lighting strand, other types of light strands are also contemplated, such as (but not limited to) 3-, 4- or 5-wire rope lights. All of the components shown in FIGS. 3A and 3B are sized to fit inside the tube portion 22 of the edging 20, so that the connectors when in use are protected both by the tube portion 22, the coupler 25 and/or the sleeve 26. Thus, when the edging 20 is installed, only the tube portion 22 (with light shining therefrom) and the coupler 25 and/or the sleeve 26 are visible above grade. FIG. 3C is a perspective view of a weather-resistant connector 35 joining two light strands 21 inside a tube portion 22 of an edging section 20. As shown in FIG. 3D, a single light strand can extend through the tube portions of several edging sections 20. The couplers 25 provide a mechanical connection between adjacent edging sections, while connectors 35 provide a weather-resistant mechanical and electrical connection between light strands.

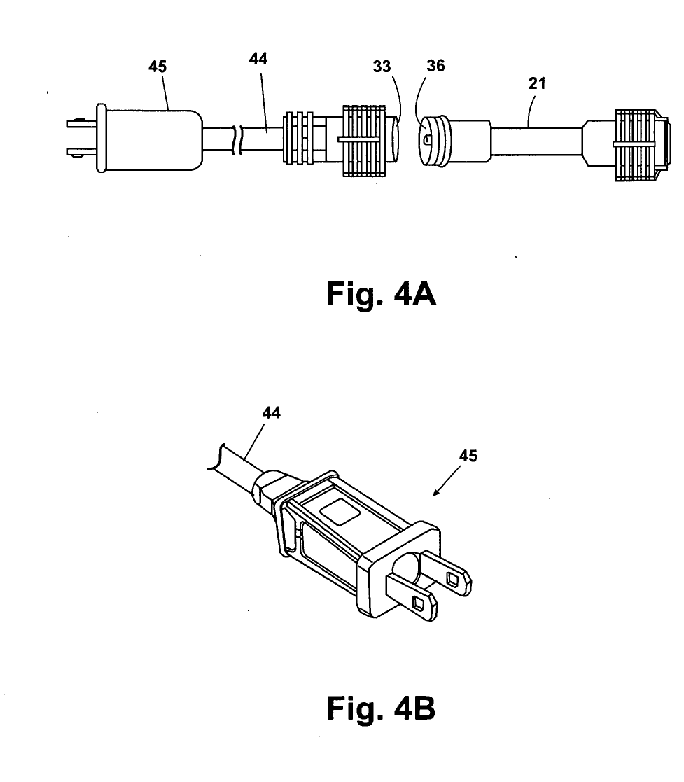

In an embodiment, one end of the light strand 21 has a connector for making an electrical connection to a power source, as schematically illustrated in FIG. 4A. Plug 36 mates with socket 33, with the electrical connection covered by coupling nut 28 threading onto thread 32, as described above. Socket 33 in turn is coupled to power cord 44 and plug 45, as shown in FIG. 4B. Plug 45 typically is polarized, and can advantageously have a fuse (e.g., a 2 W-5 W fuse) incorporated therein. The incorporation of a 2 W-5 W fuse in the plug 45 provides an additional safety feature for the consumer. Although plug 45 as shown is configured for connecting to a 120V power source, it will be appreciated that a low-voltage power source can be used instead, depending on the power requirements of light strand 21. In another embodiment, the light strand is solar-powered, and connects to a solar collector/generator rather than an external power source.

While the weather-resistant electrical connector 35 and the plug 45 are described in relation to the illuminated edging system 20, it can be used with any of the embodiments of the invention.

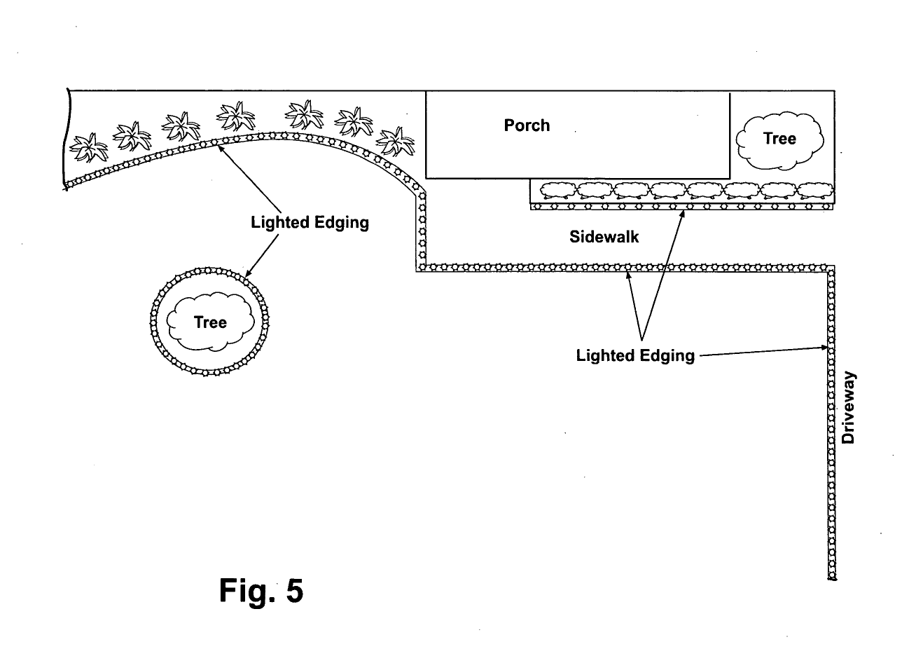

Illuminated edging in connected sections, as described above, provides inexpensive, ground-level outdoor lighting. One possible installation is shown schematically in FIG. 5, where both edges of a sidewalk are illuminated, and accent lighting surrounds a tree.

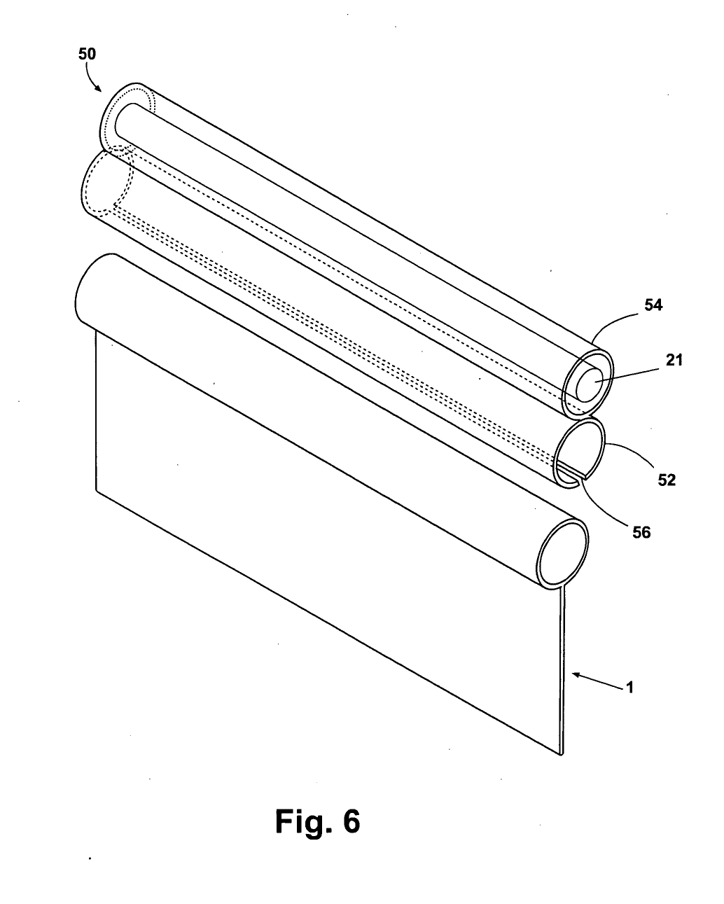

FIG. 6 illustrates an illuminated edging module 50 for mounting to an existing conventional edging 1 according to another embodiment of the invention. The illuminated edging module 50 comprises a housing having a connector portion 52 connected with a housing upper portion 54. A flexible strand of lights 21 can be installed inside the housing upper portion 54. The housing upper portion 54 is an elongated enclosure, open only at the ends thereof, and has a substantially circular cross-section. The light strand (e.g. a rope light) 21 preferably has a circular cross-section, but can have any cross-sectional shape that fits conveniently into the housing upper portion 54. The housing upper portion 54 of the illuminated edging module 50 is made of transparent or translucent plastic so that the light from the strand 21 is visible.

Sections of the light strand 21 can be connected together with the weather-resistant mechanical connecter 35 as described above with reference to the illuminated edging system 20. The light strand 21 can also have a connector plug 45 at one end for making an electrical connection to a power source as described above with reference to the illuminated edging system 20.

In an example embodiment, the connector portion 52 can be an elongated slotted hollow cylinder. A slot 56 can be disposed longitudinally along the length of the connector portion 52. The slot 56 can generally be located in the connector portion 52 opposite the area with which the connector portion 52 is connected with the housing upper portion 54.

The connector portion 52 of the illuminated edging module 50 can be formed in an extrusion process along with the housing upper portion 54 providing an illuminated edging module 50 wherein the connector portion 52 and the housing upper portion 54 have the same transparent or translucent properties. The connector portion 52 can also be formed in a co-extrusion process so that the connector portion 52 and the housing upper portion 54 are made of different materials. For example, the connector portion 52 can be formed of an opaque plastic while the housing upper portion 54 is transparent or translucent, at least in some part.

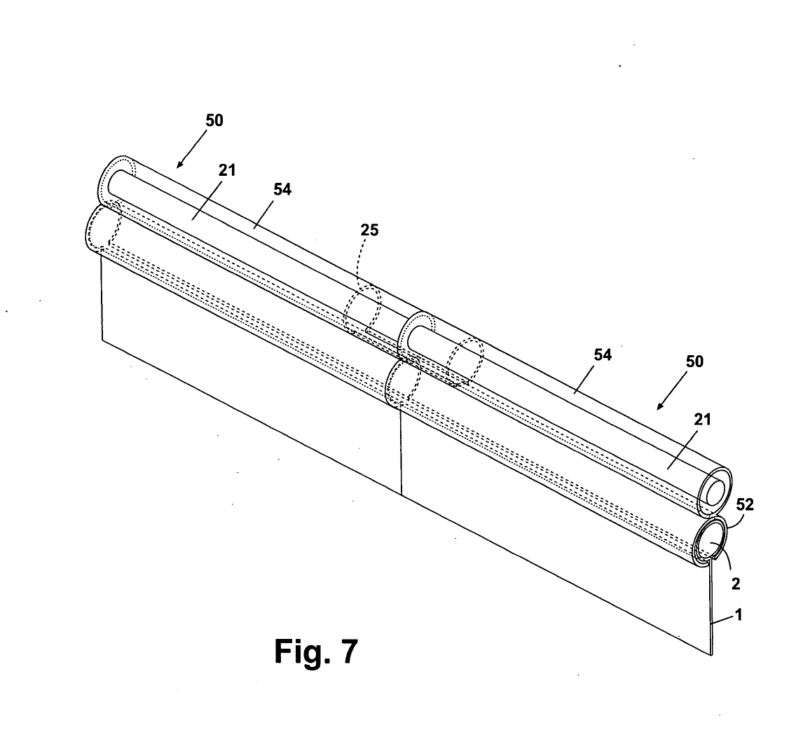

As illustrated in FIG. 7, adjacent sections of the illuminated edging module 50 can be coupled together using the coupler 25. The coupler 25 can surround the housing upper portion 54 of the illuminated edging system 50 in much the same way the coupler 25 surrounds the tube portion 22 of the illuminated edging system 20. The coupler 25 can also be disposed within the housing upper portion 54 of adjacent edging modules 50. The coupler 25 can be translucent, transparent or opaque. Alternatively, the sections of the illuminated edging module 50 can simply be attached adjacent one another along the length of the existing edging 1.

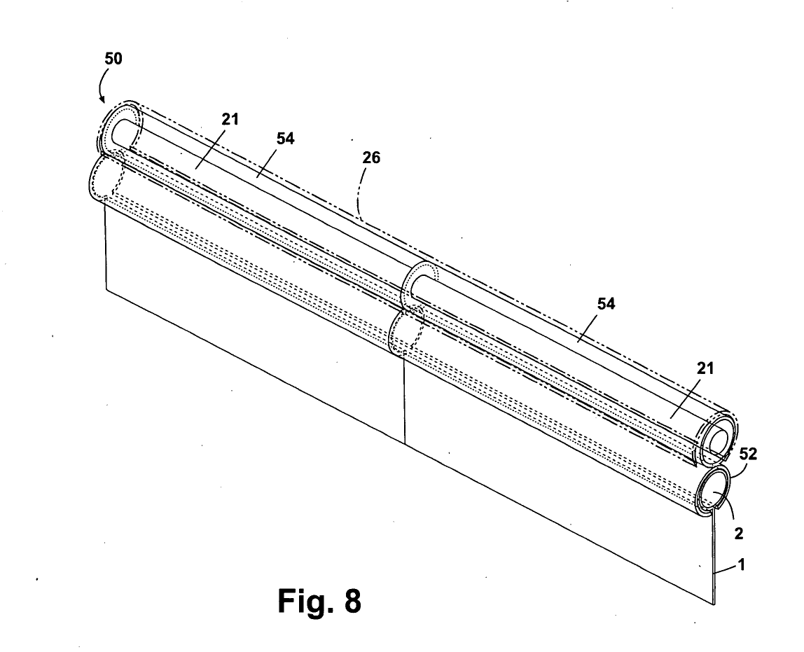

FIG. 8 illustrates the use of the sleeve 26 for providing a covering for the housing upper portion 54 of the edging module 50 in the same way that the sleeve 26 can provide a cover for the upper tube portion 22 of the edging system 20. The sleeve 26 can be used with the edging module 50 without the coupler 25 or in combination with the coupler 25.

When used in combination with the coupler 25, the sleeve 26 can snap-fit over the upper portions 54 of adjacent edging modules 50 across the coupler 25. The sleeve 26 can be sized so as to fit around the housing upper portion 54 and the coupler 25. Additionally, the sleeve 26 can be used instead of the coupler 25 to couple adjacent edging modules 50 and provide a cover for the one or more upper portions 54. The sleeve 26 can be made of transparent or translucent plastic so that light from strand 21 is visible.

The housing upper portion 54 of the illuminated edging module 50 (either alone or in combination with the coupler 25 and/or the sleeve 26) protects the light strand 21 from weather and from physical damage (e.g. by weed trimmers, by being stepped upon, etc). A UV inhibitor can be added to the plastic to protect the light strand 21 from the sun.

One of the housing upper portion 54, the coupler 25 and the sleeve 26 can be formed without coloring, or can be colored so as to impart a color to the visible light emanating from the light strand 21, or from a portion of the light strand 21. Alternatively, the lights of the light strand 21 can themselves be of a variety of colors. The lights can be incandescent or have light-emitting diodes (LEDs). Other types of light strands, such as, for example, 3-, 4- or 5-wire rope lights are within the scope of the invention. It will be appreciated that a low-voltage power source can be used instead, depending on the power requirements of light strand 21. In another embodiment, the light strand is solar-powered, and connects to a solar collector/generator rather than an external power source.

In another embodiment, the light strand 21 can be formed integrally with the housing upper portion 54 of the illuminated edging module 50, therefore eliminating the need for feeding the light strand 21 through a separate housing upper portion 54.

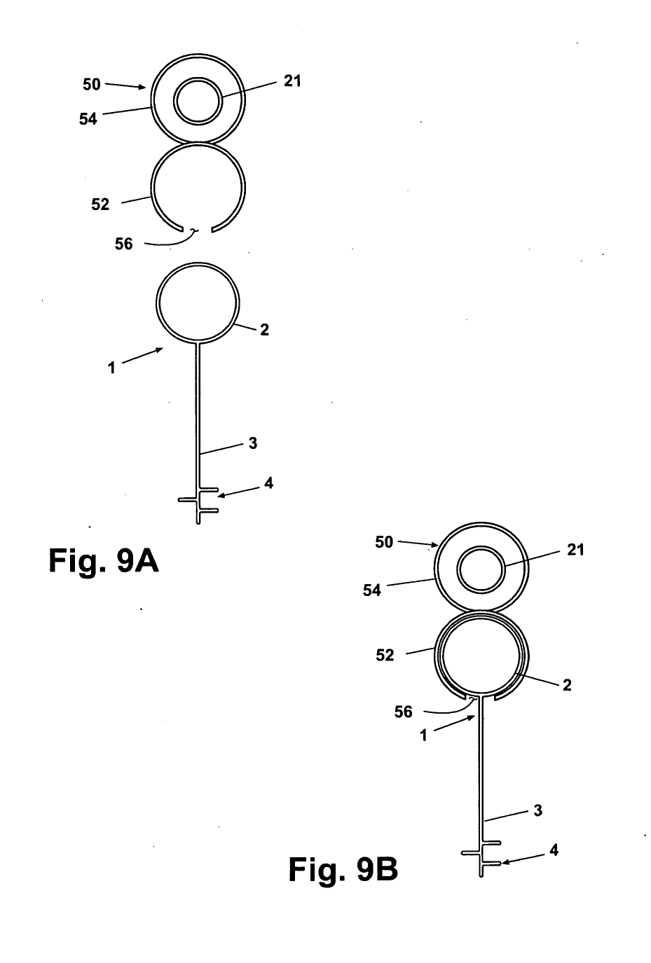

FIGS. 9A and 9B illustrate a method of connecting the illuminated edging module 50 with the existing conventional edging system 1, according to an embodiment of the invention. The illuminated edging module 50 can be added to the existing conventional edging system 1 prior to being installed or after it has been installed in the ground.

The connector portion 52 reversibly mounts the housing upper portion 54, containing the light strand 21, to the hollow tube 2 of the existing edging 1. A user positions the slot 56 of the connector portion 52 over the top of the hollow tube 2 and applies pressure in a generally downward direction. The arms of the connector portion 52 that define the slot 56 elastically deform outward around the hollow tube 2 as the illuminated edging module 50 is being pushed into position by the user. The illuminated edging module 50 can be selectively removed by the user by reversing the process and pulling the illuminated edging module 50 in a generally upward direction away from the edging 1. When the illuminated edging module 50 is in position, the lower portion 3 of the existing edging 1 is disposed longitudinally in the slot 56 of the connector portion 52.

According to another embodiment of the invention, one or more transparent or translucent colored sleeves 26 can be used with the illuminated edging module 50 similar to how it is used with the illuminated edging system 20. A long, continuous sleeve 26 can be of a single color or can have more than one color disposed along its length. The colors can be randomly disposed along the length of the sleeve 26 or they can form a repeating pattern, such as red, white and blue, for example. The sleeve 26 can also be provided in shorter, colored segments that the user can attach to the illuminated edging module 50, to generate a desired color pattern.

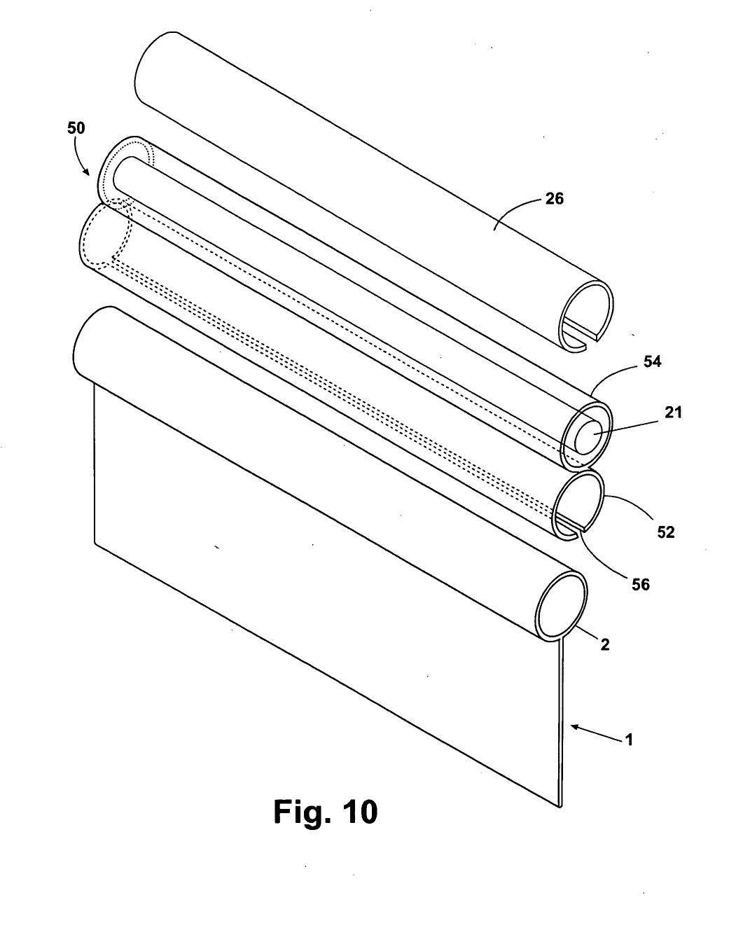

FIGS. 6 and 10 illustrate the use of the sleeve 26 with the illuminated edging module 50 illustrated in FIG. 6. According to this embodiment, the illuminated edging module 50 attaches to the upper portion 2 of an existing conventional edging 1. One or more sleeves 26 can then be attached to the housing upper portion 54 of the edging module 50 to color the light emitted from the light strand 21. The sleeve 26 can also be connected with the edging module 50 before it is connected with the existing edging 1. The sleeve 26 can be attached end-to-end to color the light emitted from the light strand 21 along the entire length of sections of the illuminated edging module 50. The sleeve 26 can also be attached to the housing upper portion 54 at discrete locations along the length of the illuminated edging module 50 to create any pattern of colored light desired by the user.

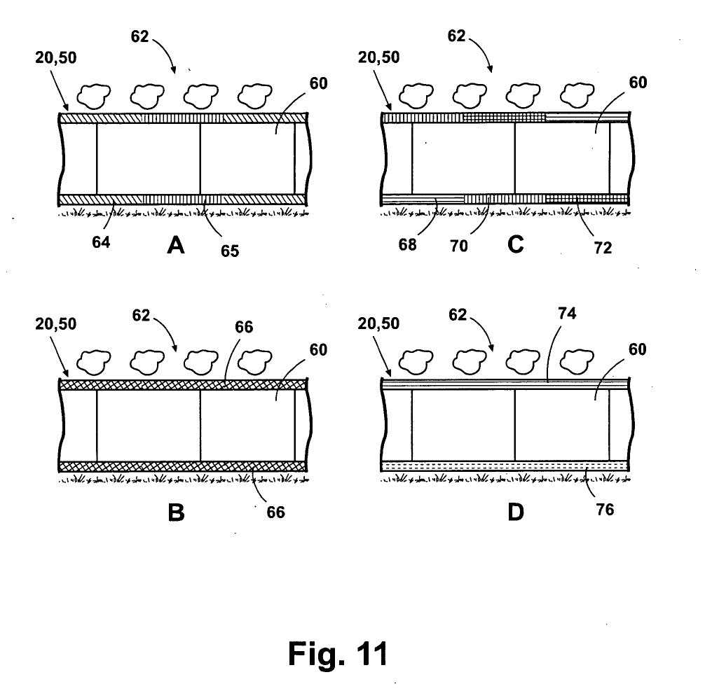

As illustrated in FIGS. 11A-D, the colored sleeve 26 can be used in a variety of ways according to the user's desired aesthetic look with the illuminated edging system 20 and the illuminated edging module 50. For example, the illuminated edging system 20 or illuminated edging module 50 can be used to illuminate and decorate a side walk 60 in front of a landscaping feature 62, such as bushes. One or more colored sleeves 26 can be snapped on top of the upper portion 22 of the illuminated edging system 20 or the housing upper portion 54 of the illuminated edging module 50 to color the emitted illumination for particular holidays.

For example, one or more red couplers 64 and one or more green couplers 65 can be attached at Christmas time (FIG. 11A); a single, long section of an orange sleeve 66 can be attached at Halloween (FIG. 11B); a set of red 68, white 70 and blue 72 sleeves can be attached during the Fourth of July (FIG. 11C), and the like.

Alternatively, the sleeve 26 can have colors which correspond to favorite sports team color combinations. For example, a silver sleeve 74 and a blue sleeve 76 for the Detroit Lions football team (FIG. 11D). The sleeve 26 can be provided in long sections with the color pattern already incorporated or the sleeve 26 can be provided in shorter, single color sections that the user can select based on the aesthetic tastes of the user.

The snap-fit design of the sleeve 26 allows the user to quickly and easily change the appearance of the light emitted from the illuminated edging system 20 and the illuminated edging module 50 without reinstalling the edging.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. An illuminated edging module for attachment to an existing edging system, the existing edging system comprising an upper portion configured to be installed above grade and a lower portion configured to be installed below grade and anchored into the ground, comprising:
a housing comprising an upper portion containing a light strand and a lower portion having a connector portion adapted to fit to the existing edging upper portion for removeable attachment thereto; and
an electrical connector operably interconnected with the light strand. portion.

2. An illuminated edging module according to claim 1, wherein at least a portion of the housing upper portion comprises one of a transparent and translucent material.

3. An illuminated edging module according to claim 1, wherein the upper portion and the lower portion are integrally formed of plastic.

4. An illuminated edging module according to claim 3, wherein the upper portion and lower portion are formed by a co-extrusion process, so that at least a portion of the upper portion comprises one of a transparent and translucent material and the lower portion comprises one of a transparent and translucent material.

5. An illuminated edging module according to claim 1, wherein the upper portion has a substantially circular cross section.

6. An illuminated edging module according to claim 1, wherein the light strand comprises a rope light.

7. An illuminated edging module according to claim 1, further comprising a plurality of modules according to the invention and at least one coupler for joining adjacent modules, the at least one coupler disposed on at least one of the exterior and interior of the respective upper portions of the adjacent modules.

8. An illuminated edging module according to claim 7, wherein the at least one coupler is formed as a slotted cylinder surrounding the housing upper portion of adjacent modules.

9. An illuminated edging module according to claim 8, wherein the at least one coupler comprises one of a transparent and translucent material.

10. An illuminated edging module according to claim 9, wherein the at least one coupler is also provided in a colored configuration to color light emitted therefrom when attached over the housing upper portion.

11. An illuminated edging system according to claim 1, wherein the housing upper portion is substantially transparent has a color, so that light from the edging module has a color in accordance with the color of the coupler.

12. An illuminated edging module according to claim 1, wherein the housing lower portion has a slotted retainer adapted to fit over the existing edging upper portion to retain the module on the existing edging.

13. An illuminated edging module according to claim 1, further comprising at least one sleeve disposed on the exterior of an upper portion of at least one module provided in a colored configuration to color light emitted therefrom when attached over the housing upper portion.
